(19) United States
(12) Patent Application Publication
(10) Pub. No.: US 2015/0314953 A1
(43) Pub. Date: Nov. 5, 2015

(54) CAPSULE FOR PREPARING A DRINK

(71) Applicant: PSR PROFITABLE STRATEGIC REDEPLOYMENT SÀRL, Fribourg (CH)

(72) Inventors: Alain MARILLER, Les Monts-de-Corsier (CH); Jean-Paul GAILLARD, Cully (CH)

(21) Appl. No.: 14/651,085

(22) PCT Filed: Dec. 10, 2013
(86) PCT No.: PCT/IB2013/060773

§ 371 Date: Jun. 10, 2015

(30) Foreign Application Priority Data
Dec. 14, 2012 (IB) PCT/IB2012/057344

(51) Int. Cl. B65D 85/804; A47J 31/40

(52) U.S. Cl. CPC B65D 85/8043; A47J 31/407

(57) ABSTRACT

The invention relates to a capsule for preparing a drink, for example coffee, comprising a space for containing a concentrated dose, for example of ground coffee, and an inlet and an outlet that both communicate with said space.

### REFERENCE TO A PRIOR APPLICATION

The present application claims the priority of the earlier application PCT/IB2012/057344 filed on Dec. 14, 2012, the content of this application being incorporated by reference in its entirety into the present application.

### FIELD OF THE INVENTION

The invention relates to the preparation of drinks, e.g. coffee, by introducing water into an element containing a concentrated dose of product, e.g. ground coffee, and by extraction of the mixture thus obtained and to the devices used for this purpose.

### PRIOR ART

Various types of elements containing a concentrated dose through which water is introduced, mixed with the concentrated dose, then extracted from the element are known.

The element is in the form e.g. of a capsule or of a capsule or of another equivalent receptacle.

Water is introduced into the element by puncturing at least one wall of the element. Extraction may be performed by puncturing, tearing or bursting a wall of the element or by another equivalent process.

Application WO 2011/024103 discloses a pouch for preparing a beverage comprising an inlet orifice and an outlet orifice communicating with a volume containing a concentrated dose for example of coffee.

### Overview of the Invention

One of the objectives of the invention is to offer an element for preparing a drink which is improved and an improved extraction machine.

Another advantage is a lower cost, ease of manufacture and operation and biodegradability.

These objectives are achieved notably by means of a capsule as defined in the claims.

According to the invention, the capsule for preparing a drink, e.g. coffee, comprises at least one volume intended to contain a concentrated dose, e.g. of ground coffee, an inlet and an outlet, both communicating with said volume.

For preference, the inlet and the outlet are positioned at distant locations on the capsule.

According to one embodiment, the capsule comprises a tubular element formed of two ends, the first being connected to the inlet, the other being positioned in said volume, at a location distant from the outlet.

According to another embodiment, the outlet is in the bottom of the capsule.

The outlet may comprise at least a filter and a membrane and at least one opening between the filter and the membrane.

The capsule may comprise several outlets and/or several openings between the filter and the membrane.

The membrane may comprise one or more region(s) of weakness and/or one or more region(s) of weakened attachment to the capsule.

The membranes are for example laminated onto the capsule.

According to another embodiment, the invention relates to a capsule cage in combination with a capsule as described in the present application.

According to another embodiment, the invention relates to a device for extracting a drink suited to the use of a capsule or a cage as described in the present application.

The walls of the capsule may be flexible, semi-rigid or fully rigid.

### DETAILED DESCRIPTION OF THE INVENTION

The invention is described in greater detail hereinafter by means of embodiments illustrated in the figures.

FIGS. 1 to 3 illustrate side and perspective views of a first embodiment of the capsule;

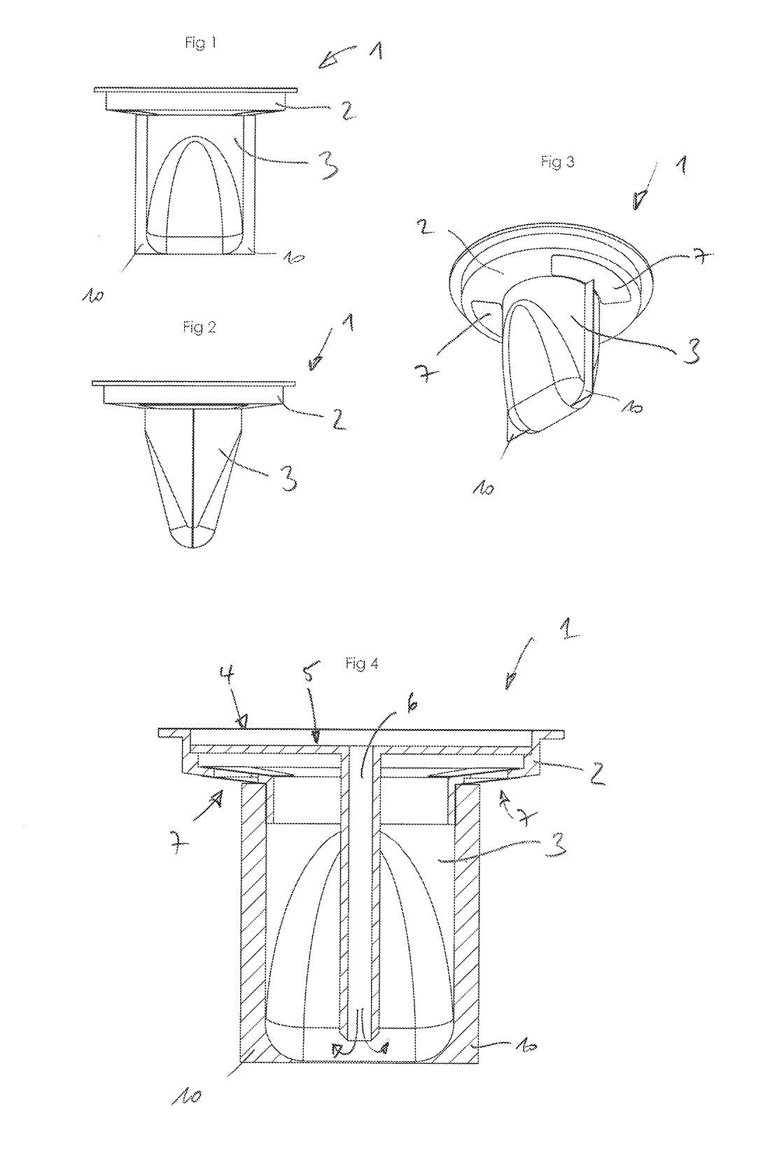

FIG. 4 illustrates a view in cross section of the first embodiment of the capsule;

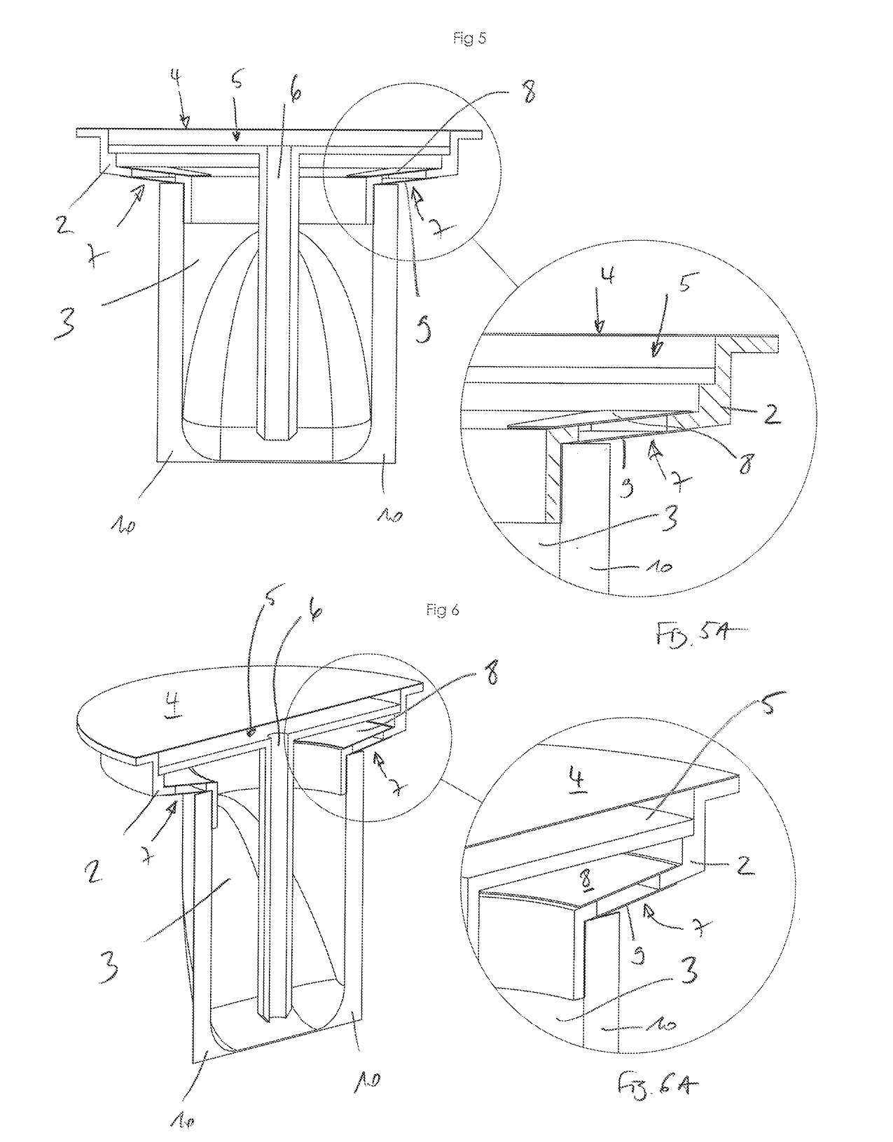

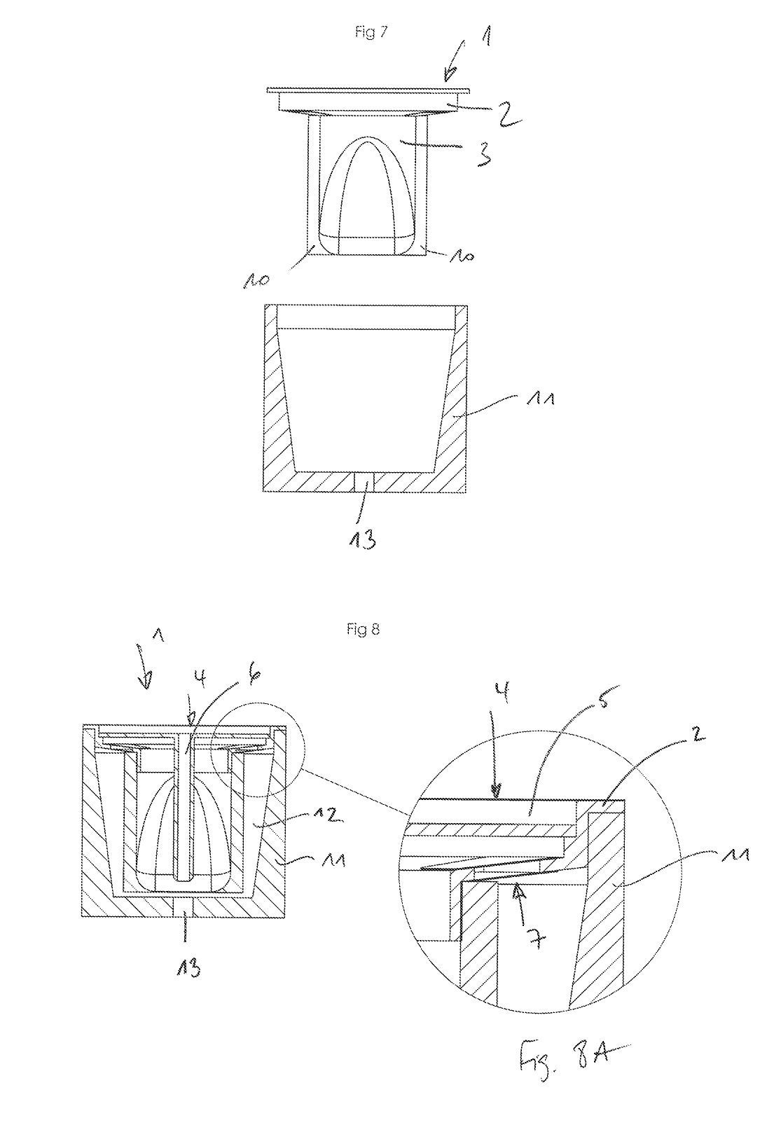

FIGS. 5, 5A, 6 and 6A illustrate detailed views in cross section of the first embodiment of the capsule;

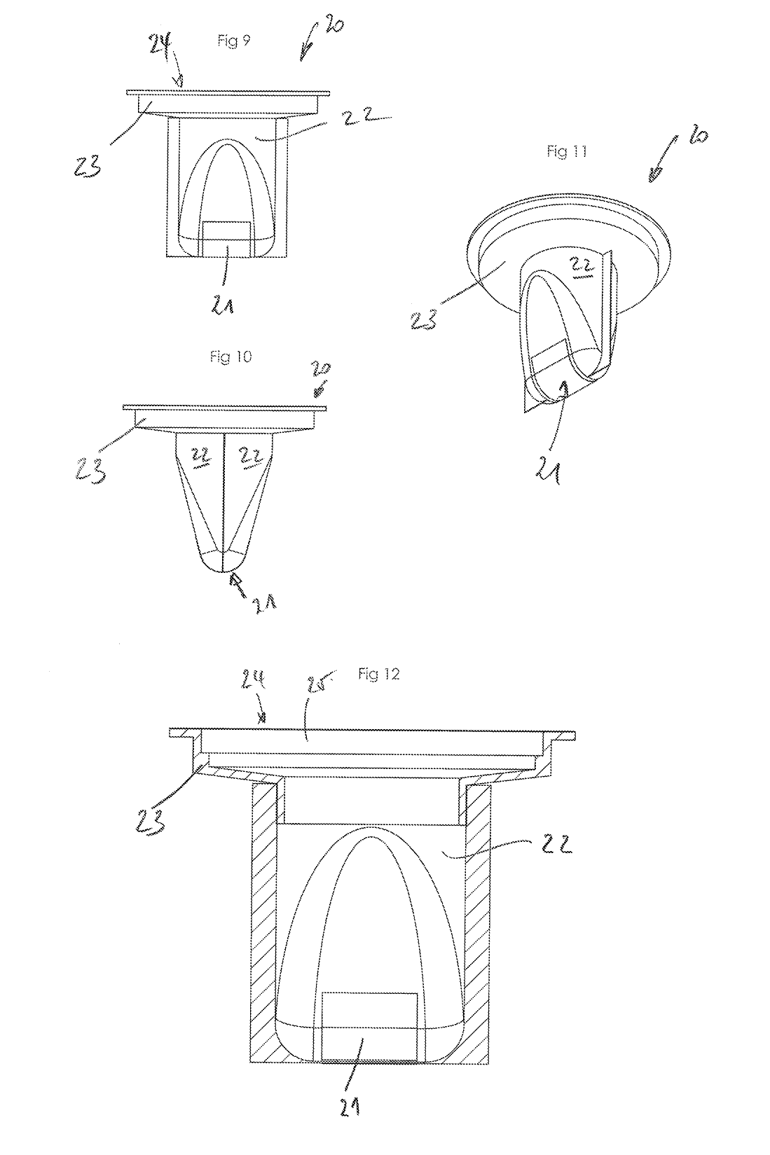

FIGS. 7, 8 and 8A illustrate a capsule placed in a cage;

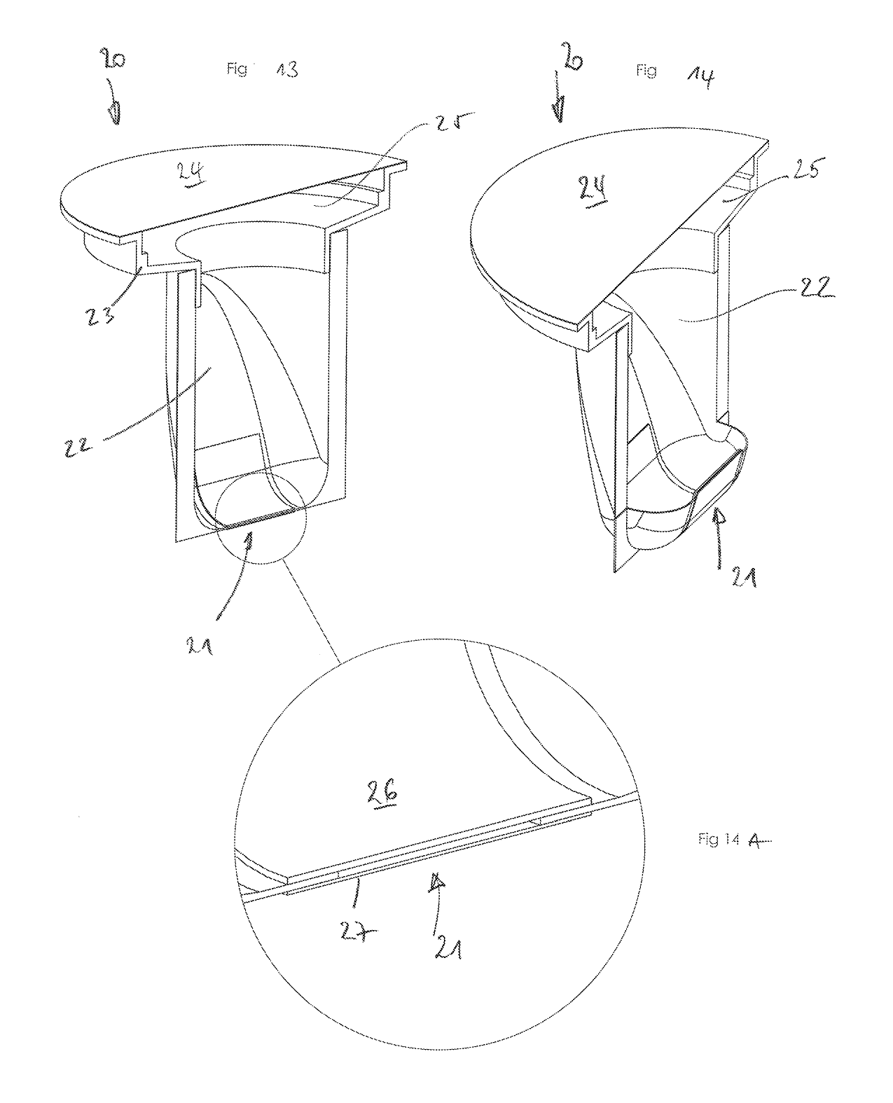

FIGS. 9 to 14A illustrate a second embodiment of the capsule according to the invention, in perspective and in cross section;

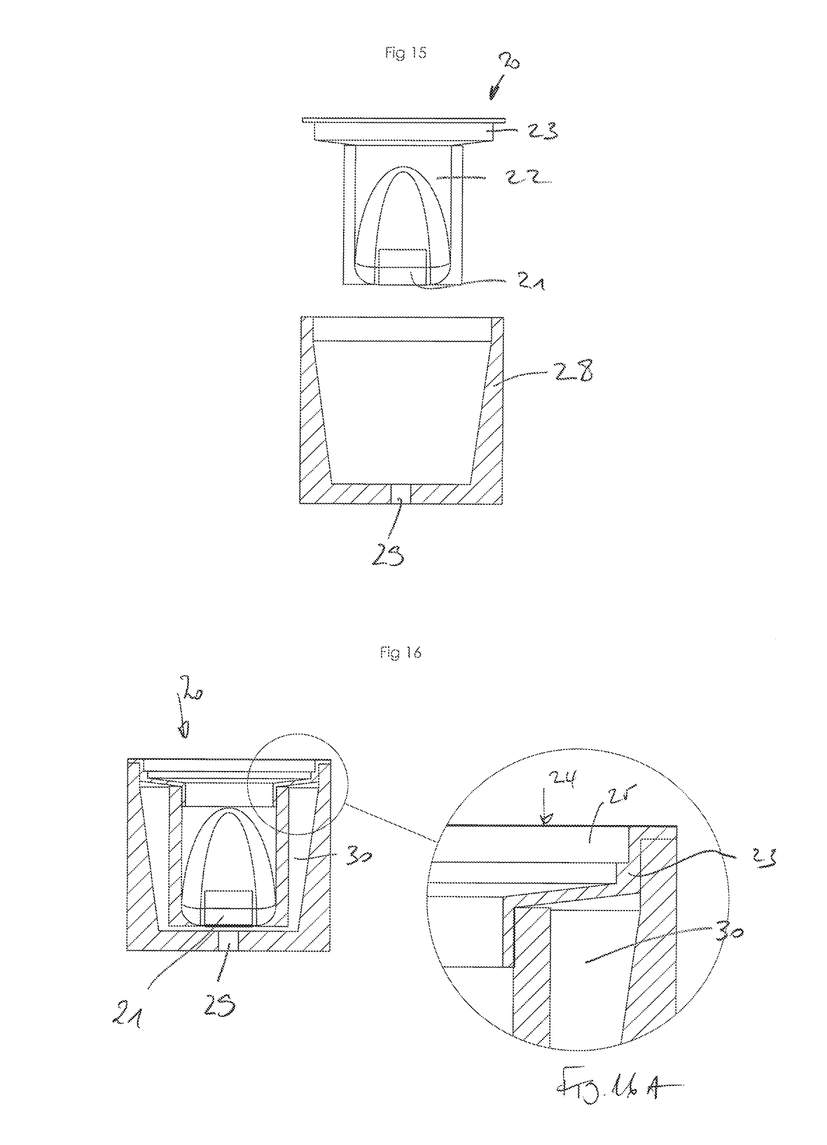

FIGS. 15, 16 and 16A (which is a detail of FIG. 16) illustrate the capsule of the second embodiment in a cage;

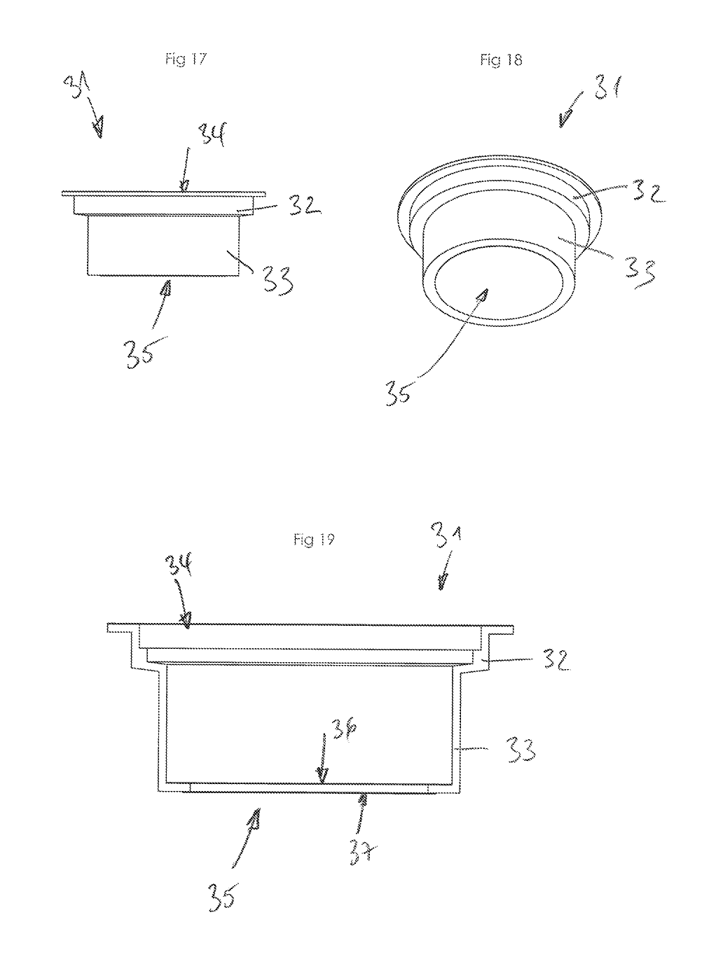

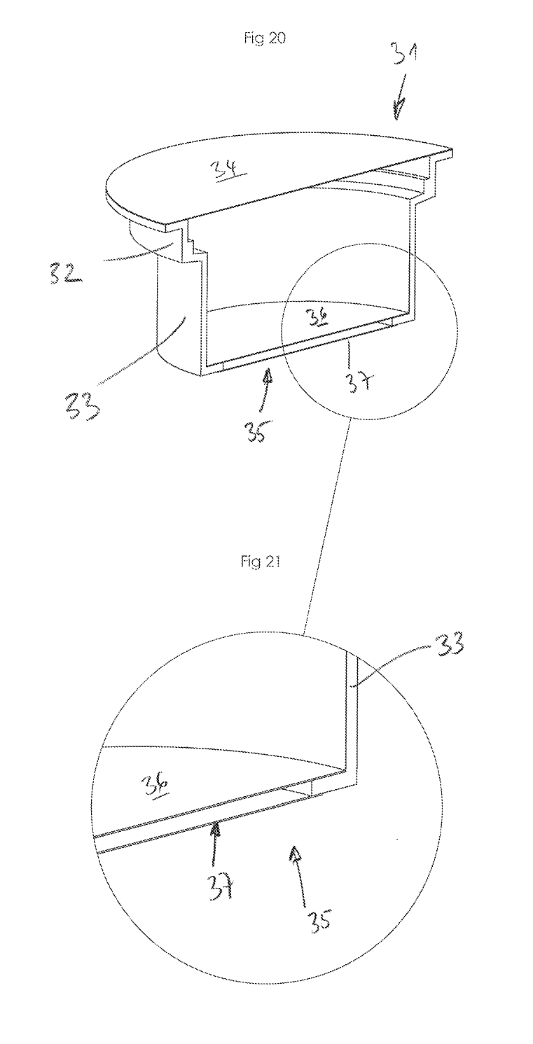

FIGS. 17 to 21 illustrate a third embodiment of the capsule according to the invention, in perspective and in cross section; and

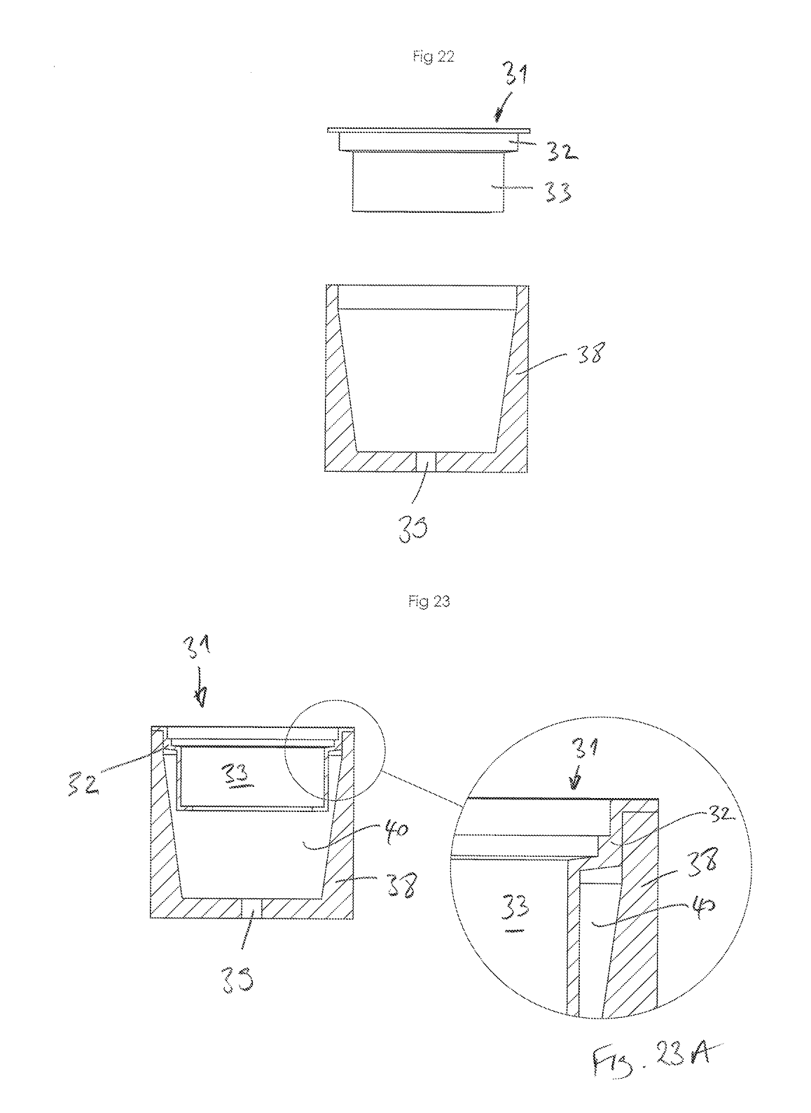

FIGS. 22 to 23A illustrate the capsule of the third embodiment in a cage.

The capsule has the overall shape of a mushroom or a cylinder with a cap 2 and a body 3, as depicted in FIGS. 1 to 3 for example.

FIG. 4 illustrates a view in cross section of the first embodiment of the capsule 1. The cap 2 comprises a membrane 4 intended to be punctured during extraction of the drink, a volume 5 into which a pressurized liquid is introduced, said liquid being extracted from the volume 5 in order to be introduced into the product contained in the capsule via a duct 6 the outlet of which is in the bottom of the body 3 of the capsule 1. Because the liquid introduced is under pressure, it will fill the body 3 of the capsule 1 and rise up (refer to the arrows in FIG. 4).

As illustrated in greater detail in FIGS. 5, 5A (which is a detail of FIGS. 5), 6 and 6A (which is a detail of FIG. 6), in order to allow the drink to be extracted from the capsule 1, the latter comprises an annular outlet 7 produced in the form of one or more outlets 7 distributed for example under the cap 2 or on the body, for example on the side of the body 3. The outlets 7 comprise, toward the inside of the capsule 1, a filter 8 and, toward the outside of the capsule 1, a closure membrane 9 and at least one opening between the filter and the membrane. Said membrane 9 becomes at least partially detached from its fixing to the capsule in order to allow the prepared drink to exit, for example, under the effect of the pressure.

In FIG. 3, two outlets 7 are illustrated, but there may be more of them (three or more . . . ) or fewer, but there is at least one. The outlet 7 under the cap 2 may be embodied by one or more piercing(s)/opening(s) or hole(s) of any shape in the cap 2.

The outlets 7 may be on the cap 2, on the body 3 of the capsule, or both, and there may be one or more openings per outlet 7.

Typically, the cap 2 may be fixed to the body 3 by welding, bonding and any other suitable method.

The body 3 may comprise a lip 10 for the manufacture thereof: for example, the body 3 may be formed of two half-containers which are assembled and welded together by the lips 10. That makes it possible to form a container (the body 3) in which the product (for example ground coffee) is placed. The capsule 1 is then closed by adding and fixing the cap 2 on the body 3.

The membrane 9 is attached to the head 2 (or to the body 3) for example by a peripheral weld. For preference, part of the weld is weaker so as to allow the membrane to be detached in the weakened region (and therefore at a chosen location). The membrane 9 can also tear under the effect of the pressure of the liquid in the capsule 1. This tearing may be induced by a weakening of the membrane or by external means (spikes etc.) situated outside, for example on the capsule cage 11 (see FIG. 7).

More specifically, FIGS. 7, 8 and 8A illustrate the capsule 1 placed in a cage 11. The capsule is introduced into the cage 11 and a free volume 12 is provided between the inside of the cage 11 and the outside of the capsule 1 into which volume the prepared drink will flow when it leaves the capsule via the openings 7.

The drink can then flow out of the cage 11 via the outlet 13. Sealing is afforded by the cap 2 and the upper edge of the cage 11, either directly or using suitable seals.

FIGS. 9 to 14A illustrate another embodiment of the capsule 20. In this embodiment, the duct 6 and the outlets 7 under the cap 2 are replaced by one (or more) outlet(s) 21 in the bottom of the capsule 22. More specifically, in this embodiment, the capsule comprises a body 22 and a cap 23. The cap 23 itself comprises a membrane 24 similar to the membrane 4 of the first embodiment, which opens onto a volume 25 which provides direct access to the product contained in the capsule. During use, the pressure in the capsule 1 will rise and the drink will pass through the filter 26 which in this embodiment is located in the bottom of the capsule rather than under the cap (as it was in the first embodiment). As it passes through the filter 26, the drink will press against a membrane 27 and the latter will rupture when predetermined conditions have been reached, such as the conditions described in respect of the membrane 7 of the first embodiment. The filter 26 may be in the form of a cup which rises up along the capsule forming a lining of the wall, something that allows for the use of a greater number of openings for letting the drink out and for a drop in pressure. Each opening may have a membrane 27 and a filter 26 or alternatively a membrane 27 and a filter may cover several openings. The filter 26 and/or the membrane 27 may be in a single piece or in several.

FIGS. 15, 16 and 16A (which is a detail of FIG. 16) illustrate the capsule 20 of the second embodiment in a cage 28. The principle is the same as in the first embodiment: a free volume 30 may be provided around the capsule 20 once the latter has been introduced into the cage 28, and the cage 28 comprises an opening 29 for the flow of the drink leaving the capsule via the outlet 21.

FIGS. 17 to 23A illustrate another embodiment of the capsule 31.

This capsule comprises a cap 32 and a body 33 the two of which may be formed in a single piece. The capsule further comprises a membrane 34 which will be punctured/torn to allow the liquid to enter the product contained in the capsule 31. The bottom 35 of the capsule 31 comprises a filter 36 and a membrane 37 similar to the membrane 9 and 27 of the previous embodiments. The filter 36 may be in the form of a cup which rises up along the capsule forming a lining of the wall, something that allows for the use of a greater number of openings situated for example on the bottom and on the sides of the body 33 for letting the drink out and for a drop in pressure. Each opening may have a membrane 37 and a filter 36 or alternatively a membrane 37 and a filter 36 may cover several openings. The filter 36 and/or the membrane 37 may be in a single piece or in several.

As illustrated in FIGS. 22, 23 and 23A, the capsule 31 is introduced into a cage 38 and preferably leaves a gap 40 in which the prepared drink collects once it has left the capsule 31 via the bottom 35. The drink will be able to leave the cage 38 via the outlet 39.

The elements of the capsule 1 may be made of any suitable material: for example biodegradable materials, synthetic or metallic materials. The body and the cap may be in a single piece or in two or more parts. For preference, the capsule, particularly the bodies 3 and 22 of the first two embodiments, are made of flexible material(s) and that of the third embodiment(s) of rigid material(s). Of course, the capsules of the first two embodiments may also be made entirely of rigid material(s).

The capsule and/or the body thereof may have different sizes. The choice of size may be connected with the drink prepared (e.g. coffee, tea or other) or with the desired quantity of drink (e.g. one or more cups, espresso or long coffee, etc.).

The elements are attached using suitable methods, notably according to the materials used: welding (fusion bonding, ultrasonic welding, etc.), pressing, clipping, adhesive bonding, etc.

To open it, the outlet membrane (9, 27, 37) may have one or more region(s) of deliberate weakness or alternatively one or more weakened capsule-attachment region(s) to make it easier to open in a controlled manner. Additional puncturing means, for example connected with the capsule cage 11, 28, 38, may also be provided. The same principle may apply to the membrane 4, 24, 34.

Each opening may have its own membrane 9, 27, 37 or alternatively one membrane may cover several openings. Likewise, each outlet may have a filter 8, 26, 36 or alternatively one filter may cover several outlets.

The invention is not restricted to the embodiments described and alternative forms are conceivable without departing from the scope of the protection claimed. The embodiments described and features thereof may be combined with one another as desired, according to the circumstances.

1. A capsule for preparing a drink, e.g. coffee, comprising at least one volume intended to contain a concentrated dose, e.g. of ground coffee, an inlet and an outlet, both communicating with said volume.

2. The capsule as claimed in claim 1, in which the inlet and the outlet are positioned in proximity to one another.

3. The capsule as claimed in claim 1, comprising a tubular element formed of two ends, the first being connected to the inlet, the other being positioned in said volume, at a location distant from the outlet.

4. The capsule as claimed in claim 1, in which the inlet and the outlet are not positioned in proximity to one another.

5. The capsule as claimed in claim 1, in which the outlet is in the bottom of the capsule.

6. The capsule as claimed in claim 1, made of a flexible material and/or a rigid material.

7. The capsule as claimed in claim 1, in which the outlet comprises at least a filter and a membrane and an opening between the filter and the membrane.

8. The capsule as claimed in claim 1, comprising several outlets.

9. The capsule as claimed in claim 6, in which the membrane comprises one or more region(s) of weakness and/or one or more region(s) of weakened attachment to the capsule.

10. The capsule as claimed in claim 1, in which the membranes are laminated onto the capsule.

11. A capsule cage in combination with a capsule as claimed in claim 1.

12. A device for extracting a drink suited to the use of a capsule or of a cage as defined in claim 11.

13. A device for extracting a drink in combination with a capsule or a cage as defined in claim 11.
